(19) United States
(12) Patent Application Publication
(10) Pub. No.: US 2010/0332376 A1
(43) Pub. Date: Dec. 30, 2010

(54) System and Method for Auction Negotiation

(75) Inventors: Laurentiu Alexandru Vasiliu, Galway (IE); Ilko Grigorov, Galway (IE); Will Fleury, Co. Offaly (IE); Daniel Paraschiv, Galway (IE)

Correspondence Address: SULLIVAN & WORCESTER LLP, 1666 K Street NW, Washington, DC, 20006, US

(73) Assignee: National University of Ireland, Galway, established by charter dated 1908, Galway (IE)

(21) Appl. No.: 12/866,467

(22) PCT Filed: Feb. 2, 2009
(86) PCT No.: PCT/IB09/00169

§ 371 Date: Aug. 6, 2010

(30) Foreign Application Priority Data
Feb. 8, 2008 (IE) S2008/0098

(51) Int. Cl. G06Q 40/00

(52) U.S. Cl. 705/37

(57) ABSTRACT

An auction method is operable in a first computing device that is arranged to communicate with a plurality of second computing devices across a network, each of the second computing devices being controlled by a respective party. The auction method comprises, at the first computing device, generating a request for an offer comprising at least one negotiable parameter, the request being sent to a plurality of parties participating in the auction. The first computing device is responsive to a respective offer being received from a plurality of the parties, each offer comprising a value for each of one or more parameters including the at least one negotiable parameter, to identify a current best offer by combining the parameter values to provide a ranking value for each offer. Responsive to the current best offer failing to be identified as a successful offer, a request for a better offer is sent to at least some of the parties.

The present invention relates to a method and system for auction negotiation.

### BACKGROUND OF THE INVENTION

Methods and apparatus for performing auctions and/or sales negotiations are well known in the art.

Typical systems comprise at least one software agent acting as a client and arranged to negotiate with at least one software agent acting as a provider.

U.S. Pat. No. 7,249,085 discloses a method and system for conducting electronic online auctions using multi-parameter price equalization bidding. Bids defined in a context of a bidder are transformed into a comparative bid parameter that enables a common basis of comparison for the submitted bids. A transformed bid of a first bidder can also be detransformed into a context of a second bidder, thereby enabling each individual bidder to view a comparison of submitted bids in their own context.

US 2004/0117201 and related US 2004/0088264, Preist disclose automatic contract negotiation between a negotiating agents based on a multi-dimensional preference map which assists the agent in making decisions and recommendations based on a users preference embodied in the map.

U.S. Pat. No. 7,103,580, Batachia discloses a system and method of peer-to-peer negotiation between two parties. Firstly, the issues of negotiation are agreed between the parties. Subsequently, the negotiation process comprises an alternating succession of offers and counter-offers of values of variables representing the issues. The iteration continues until one party accepts a counter-offer, or one of the parties terminates the negotiation.

### DISCLOSURE OF THE INVENTION

The present invention provides an auction method operable in a first computing device arranged to communicate with a plurality of second computing devices across a network, each of said second computing devices being controlled by a respective party, the method comprising, at said first computing device:
a) generating a request comprising at least one negotiable parameter;
b) sending said request for an offer to a plurality of parties participating in the auction;
c) iteratively repeating steps d) and e) until a best offer is identified as a successful offer:
   d) responsive to receiving a respective offer from a plurality of said parties, each offer comprising a value for each of one or more parameters including said at least one negotiable parameter, identifying a current best offer by combining said parameter values to provide a ranking value for each offer and comparing said ranking values for each offer; and
   e) responsive to failing to identify said current best offer as a successful offer, sending a request for a better offer to at least some of said parties; and
f) accepting said successful offer.

Preferably, said request further comprises at least one non-negotiable parameter.

Preferably, said negotiable and non-negotiable parameters are any combination of continuous, categorical and discrete ordinal parameters.

Preferably, said parameters are weighted in accordance with a user's preference.

Preferably, step e) comprises sending said request for a better offer to those parties not having sent the offer identified as the current best offer.

Alternatively, step e) comprises sending said request for a better offer to those parties from whom an identical offer has not been received twice.

Preferably, the method further comprises:
g) sending an indication of success to the party from whom the successful offer was received.

Alternatively or in addition, the method further comprises:
g) sending an indication of failure to those parties from whom the successful offer was not received.

Preferably, said generating said request comprises: utilizing information pertaining to previous auctions.

Preferably, said information comprises previous requests, successful parties, successful offers, unsuccessful parties, unsuccessful offers, number of offers received per party, duration of auction and number of parties involved in the auctions.

Preferably, said identifying said current best offer includes employing non-request specific information.

Preferably, said non-request specific information comprises information derived from previous auctions.

Preferably, said identifying includes employing a multiple criteria decision analysis method such as TOPSIS, PROMETHEE, ANP, or any suitable multi-criteria decision making method that considers interdependencies between all considered parameters.

Preferably, said request comprises a quota selection field for pre-assigning percentages of the offer to respective ones of said parties.

The present invention further provides an auction method operable in a second computing device arranged to communicate with at least a first computing device across a network, said first and second computing devices being controlled by respective parties, the method comprising, at said second computing device:
a) responsive to a request comprising at least one negotiable parameter for an offer from said second party, selecting a starting offer comprising a value for each of one or more parameters including said at least one negotiable parameter, from a strategy of offers and sending said offer to said party;
b) until an indication of an outcome is received and in responsive to receipt of a request for a better offer from said party, iteratively selecting a subsequent offer from the strategy of offers and sending said offer to said party.

Preferably, said request further comprises at least one non-negotiable parameter.

Preferably, said negotiable and non-negotiable parameters are any combination of continuous, categorical and discrete ordinal parameters.

Preferably, at least one of said parameters of said request comprises a range of values.

Preferably, said method comprises adjusting a range of at least one parameter value of said offer during said auction.

Preferably, said method comprises generating at least one strategy comprising a plurality of offers.

Preferably, said generating comprises employing information pertaining to previous auctions.

Preferably, said generating comprises weighting said parameters of said offer in accordance with a user's preference.

Preferably, said method further comprises selecting said strategy from a plurality of strategies, each suitable for a specific market condition.

Preferably, said strategy selecting comprises employing game theory algorithms.

Alternatively or in addition, said strategy selecting comprises employing information pertaining to previous auctions.

Preferably, said method comprises determining a profitability value associated with each offer in said strategy.

Preferably, said selecting an offer from a strategy comprises selecting a less profitable offer than a previously selected offer.

Preferably, said method comprises designating an offer in said strategy as a starting offer.

Preferably, said method comprises designating a level of profitability for a strategy as a threshold profitability.

Preferably, said selecting an offer from a strategy comprises selecting an offer having said threshold profitability when a previous offer selected had said threshold profitability.

Preferably, said method comprises adjusting or reselecting said starting offer based on information pertaining to the auction.

Preferably, said method comprises adjusting or reselecting said profitability threshold based on information pertaining to the auction.

Preferably, said method comprises identifying a parameter as having a weight of less than a threshold and replacing said parameter with an alternative to produce an amended offer.

### BRIEF DESCRIPTION OF THE DRAWINGS

Embodiments of the invention will now be described by way of example with reference to the accompanying drawing, in which:

FIG. 1 is a block diagram of an auction based system according to the preferred embodiment of the present invention;

FIG. 2 is a flow diagram of activities performed by a client agent according to the preferred embodiment of the present invention; and

FIG. 3 is a flow diagram of activities performed by a provider agent according to the preferred embodiment of the present invention.

### DESCRIPTION OF THE PREFERRED EMBODIMENT

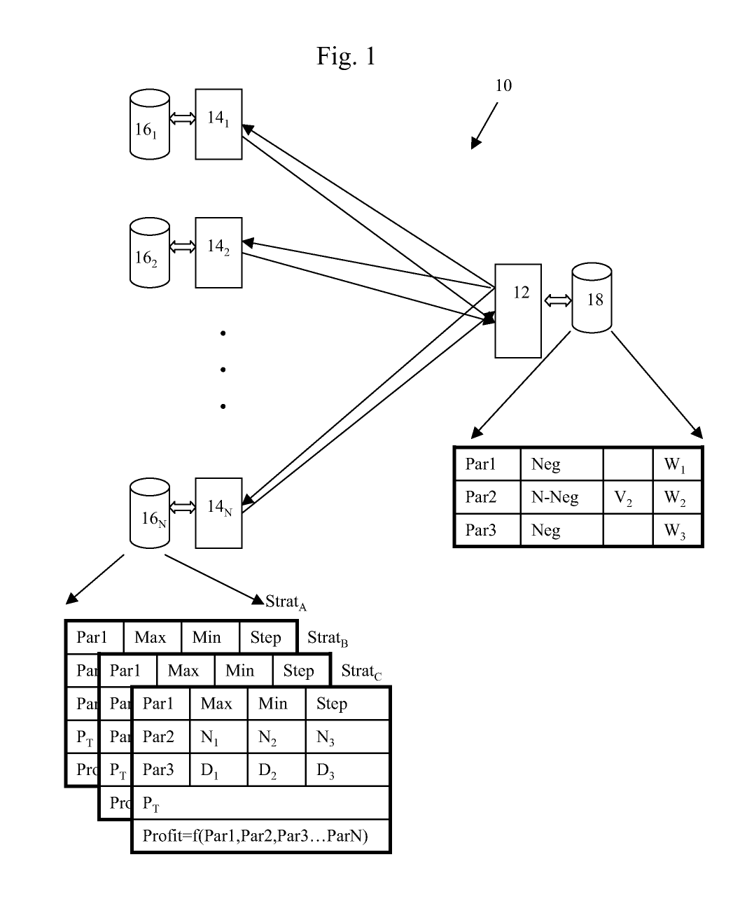

Referring to FIG. 1, there is illustrated an auction based system 10 according to the preferred embodiment of the present invention. The system comprises a client 12 and a plurality of providers, 14₁-14_{N}, arranged to communicate with the client 12. Each of the providers, 14₁-14_{N}, is associated with a respective database 16₁-16_{N}.

In the preferred embodiment, the client 12 is arranged to generate a request to be sent to the providers 14₁-14_{N}. The request comprises a plurality of parameter fields, Par₁, Par₂, Par₃, which may comprise any combination of discrete ordinal, continuous or categorical values. In the preferred embodiment, the request comprises a plurality of negotiable, Neg, and non-negotiable, N-Neg, parameters. The negotiable, Neg, and non-negotiable parameters, N-Neg, may be single values or ranges of values.

For example, if the client wishes to purchase a car, the parameter fields may comprise a negotiable range of values the client is prepared to pay, i.e. a continuous parameter, a negotiable colour, i.e. a categorical parameter, a non-negotiable car manufacturer, i.e. a categorical parameter, and a negotiable range of years, i.e. a discrete ordinal parameter. However, it will be appreciated that an offer may simply comprise a single negotiable parameter.

The parameters of the request are weighted in accordance with importance to the client and each request is therefore associated with a client preference value expressed as a function of the weighted parameters.

In the preferred embodiment, the request may comprise parameters having a weight below a threshold value, which thereby serves to indicate to a provider that although the parameter is preferable, the client is willing to consider an offer in which the relative low weighted parameter is replaced with an alternative. In this way, a client may, in response to a request, be presented with an enriched set of commercially viable options to choose from and possibly a new, more preferable offer than that originally requested.

For example, a client wishing to purchase a car may indicate a relatively low weighted preference for the car to include an mp3 player. A provider, realizing that the weight of the mp3 parameter is lower than the threshold, and therefore susceptible to an alternative, replaces the parameter with an offer including a satellite navigation system.

In the preferred embodiment, the request comprises a quota selection field. The quota selection field can be populated to pre-assign percentages of the transaction to specific providers. For example, a client may wish to reward a specific provider by ensuring that the provider is involved in providing at least a certain percentage of the transaction. However, by setting the quota selections to NULL, or alternatively, by disabling the quota selections, no provider is pre-assigned a right to supply any percentage of the transaction, and all providers may compete for the transactions.

In an alternative embodiment, a client may choose to be presented with a pre-defined number of offers, m, regardless of the percentage applicability of the offers to the request. To this end, at least one parameter, p, of the request is associated with a given range, r, increment value, i, by which the range may be adjusted, and an iteration value x, indicating a number of times the range r should be incremented by the increment value i.

In the case that less than m offers are received, the range r of the parameter p is increased by the increment value i in order to increase the possibility of receiving more offers. Where again less than m offers are nonetheless received, the range of parameter p is subsequently increased by the increment value i, and this process is repeated until the number of offers presented to the client reaches m offers, or the range r of parameter p has been incremented by the iteration value x. In the former case, and where the request comprises a second parameter having a given range, increment value, and iteration value, the range of the second parameter is then incremented in the same manner. This process is repeated until m offers have been presented to the client, or alternatively, the ranges of all suitable parameters forming the request have been incremented by their iteration value x.

In this embodiment, preferably, each parameter has an associated weight which dictates which parameter is first modified in order to increase the number of offers m being provided to the client. For example, if a request comprises parameters pₐ, p_{b} and p_{c}, where parameter p_{b} has an importance weighting less than that of pₐ and p_{c}, then parameter p_{b} will be the first parameter modified in order to increase the number of offers provided to the client.

A similar method may be employed in order to reduce the number of offers being supplied to the client in which case the range r of parameter p is decreased by the increment value i for as many of the number of iterations of iteration value x necessary. In such an embodiment, the range of the highest weighted parameter is preferably altered first.

In the preferred embodiment, each database 16₁-16_{N} comprises a plurality of bid strategies, Strat_{A}, Strat_{B}, Strat_{C} Each strategy of bids is suitable to a specific market condition and fluctuations in market conditions are taken into consideration when devising the most appropriate strategy of bids. Preferably, game theory algorithms are employed to determine an appropriate strategy for the current market conditions.

Each bid strategy Strat_{A}, Strat_{B}, Strat_{C}, comprises a plurality of bids, ranked in order of profitability to the provider 14₁-14_{N}. The bids comprise a plurality of parameter fields corresponding to the fields of the request generated by the client 12. For example, if the providers were a vehicle sales company, the parameter fields may indicate the cost, colour, manufacturer and year of the car the provider is prepared to offer the client.

However, it will be appreciated that any offer sent to the client may not comprise values for at least one of the parameters. For example, where a request includes non-negotiable parameters, it can be assumed that if a provider responds to the request they have agreed to the non-negotiable parameter values.

Furthermore, it will be appreciated that a provider may supply an offer comprising additional parameters not specified in the received request. When for example communication between the client and the suppliers is implemented in a structured language format, such as, XML or RDF, additional tagged fields can be included by some suppliers which can be optionally processed by the client, particularly, if this information could be used in discriminating between similar offers from different providers.

In the preferred embodiment, each of the parameters associated with a bid are weighted in accordance with importance or profit to the provider and the profitability of the offers is expressed as a function of the weighted parameters. For example, in the case of car sales, cost may be considered an important parameter and as such may be weighted more heavily than colour. As such, the profitability of the offer is more highly reliant on the cost parameter.

In the preferred embodiment, a first offer made to the client is the most profitable bid of the strategy, with subsequent bids being progressively less profitable to the provider. Each strategy may have a threshold profitability value, P_{T}, associated with it representing the least profitable offer a provider is entitled or authorized to make to a client. Similarly, a suitable starting bid in the strategy may be selected depending on the circumstances of the auction. In the preferred embodiment, the starting bid and/or the profitability threshold may be selected based on information derived from a request received from a client. However, it will be appreciated, that the started bid and the threshold profitability value may be selected prior to receipt of a request from a client.

In one embodiment, each strategy comprises a selection of bids, each having a pre-calculated profitability associated with it.

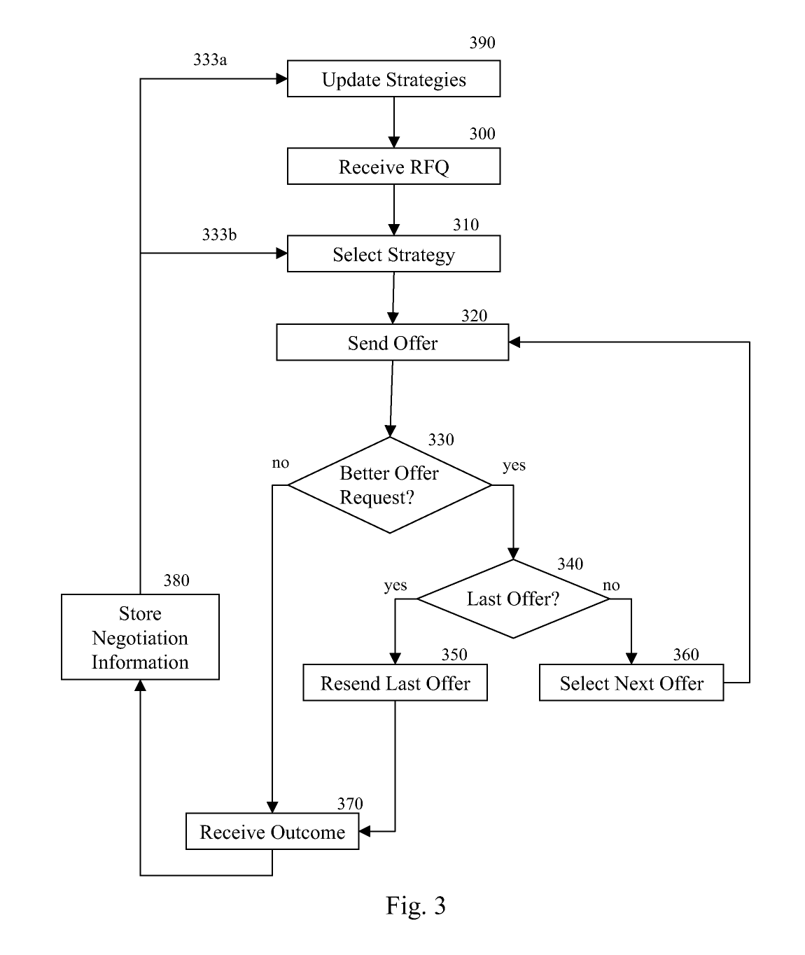

In the present embodiment, the threshold profitability value, P_{T}, is variable and can be adjusted according to information derived at the outcome of an auction by means of a first feedback loop, 333a, as illustrated in FIG. 3. Similarly, the weighting associated with each of the parameters may be adjusted.

Furthermore, a second feedback loop, 333b, as illustrated in FIG. 3, enables the profitability of each individual bid to be adjusted dynamically during an auction by altering a range of one or more parameters of the bid to be offered in light of the progression of the auction. In this way, the provider's strategies can be improved to their advantage by adjustment in light of the trends of the other providers taking part in the auctions.

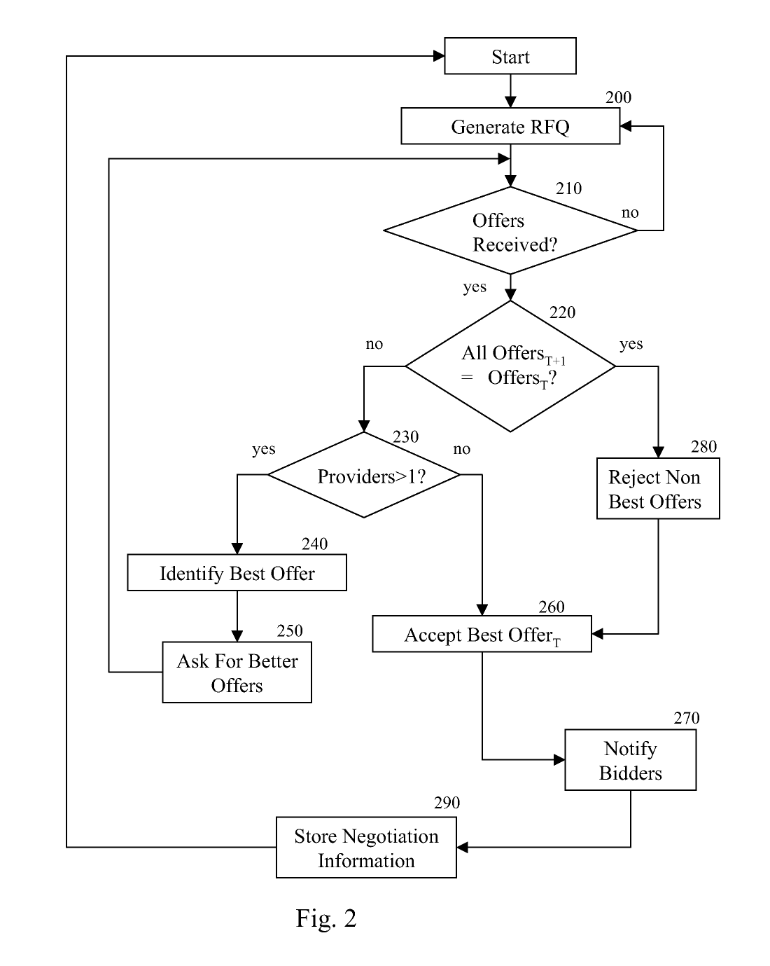

Referring now to FIG. 2, a flow diagram depicts activities of the client 12 according to the preferred embodiment of the present invention.

A request comprising a plurality of negotiable and non-negotiable parameters is generated and sent to a plurality of providers 14₁-14_{N}, 200. In the preferred embodiment, information pertaining to previous auctions is utilized when generating the request.

The client 12 awaits offers from providers, 210.

Any offers received from providers 14₁-14_{N} are rated and ranked using the multiple criteria decision analyses methods (MCDM), such as TOPSIS, (Technique Ordered Preference by Similarity to the Ideal Solution), as disclosed in Hwang, C. L and Yoon, K., “Mutiple Attribute Decision Making: Methods and Applications”, Springer-Verlang, Berlin 1981, and http://www.stat-design.com/Software/Triptych/TOPSIS.htm, PROMETHEE (Preference Ranking Organization METHod for Enrichment Evaluations), as disclosed in Mareschal, J.-P.B.a.a.B, “How to select and how to rank projects: the PROMETHEE method”, European Journal of Operational Research, 1986, Vol. 24, and (http://www.visualdecision.com/Pdf/How%20to%20use%20PROMETHEE.pdf), ANP (Analytic Network Process), as disclosed in Saaty, T., “Decision Making With Dependence and Feedback: The Analytic Network Process”, 1996: RWS Publications, Pittsburgh, or any suitable multi-criteria decision making method that considers interdependencies between all considered parameters

The provider having the highest or best ranked offer, Best_Offer_{T} is then held in standby while a request for a better offer is generated and sent to the other providers 14₁-14_{N} in the auction.

In the preferred embodiment, receipt of the same offer twice from a single provider is an indication to the client that the provider is not authorized to supply a more competitive bid and that provider is ignored for the remainder of the auction. Thus, if all non-best offer providers supply the same offer a second time 220, the client rejects these offers, 280 and accepts the last best offer received, 260.

All providers who took part in the auction are notified of the outcome, 270, and information pertaining to the auction, such as the provider supplying the winning bid and quality of offers supplied by the providers, is stored, 290, for use by the client in subsequent auctions.

In an alternative embodiment, only the provider supplying the winning bid is notified of the outcome of the auction. As the non-winning bid providers have sent the same offer twice, they are already aware that their offer has not been accepted as the winning bid.

If all non-best offer providers do not supply the same offer a second time 220, and there is more than one provider competing in the auction, 230, the offers received are rated and ranked. If a subsequent offer, Best_Offer_{T+1}, is ranked as a better offer than the previous best offer, Best_Offer_{T}, the subsequent offer is stored as the best offer, 240, and a request for better offers is generated and sent to all non best offer providers, including the previous best offer provider, 250. Otherwise, the previous best offer Best_Offer_{T} remains the best offer, 240, and the same non-best offer providers are again sent a request for a better offer, 250.

In the unlikely case that a subsequent best offer, Best_Offer_{T+1}, received from a provider is the same as the previous best offer, Best_Offer_{T} received from a different provider, non-request specific criteria may be employed to choose a preferable offer. Such criteria may be based on information determined from previous auctions with the provider such as the fact that the provider is a regular bidder, and/or provides a higher rated customer service, or external criteria such as customer reviews, in order to rank one offer above the other. In an alternative embodiment, additional parameters in an offer received may be employed to choose a preferable offer.

In the preferred embodiment, the automated request may be adjusted based on information derived from previous auctions. For example, if no providers are supplying offers 210, it may be necessary to re-define the request, 200.

Referring now to FIG. 3, a flow diagram depicts activities of the providers 14₁-14_{N} according to the preferred embodiment of the present invention.

A request for an offer is received, 300.

A strategy of bids is selected from the database 16₁-16_{N} in light of current market trends, 310, and the provider 14₁-14_{N} sends the most profitable bid of its selected strategy to the client 12, 320.

If this offer is deemed to be the client's best offer, it will be held and all other providers will be asked to provide better offers.

If it is not deemed to be the client's best offer, the provider will receive a request for a better offer, 330. As long as the threshold profitability value hasn't been reached, 340, the next most profitable bid from the strategy is supplied to the client, 360.

If the client continues to request better offers, 330 and the threshold profitability value is reached, 340, the provider resends the final offer, or threshold profitability value offer 350, thereby indicating to the client 12 that they are not authorized to supply any lower profitability offers.

In any case, the provider is notified of the outcome of the auction, 370, and information pertaining to the auction such as the request, duration of auction, and success of providers bids is stored, 290, for use by the provider in subsequent auctions by updating schedule of bids available, 390 and adjusting the threshold profitability value of bids in the schedule, 310.

In an alternative embodiment, non-successful providers are not notified of the outcome of the auction. However, the loss of an auction by a provider can be inferred by the fact that a final offer was resent to the user.

In the preferred embodiment, the first feedback loop, 333a is provided to adjust the profitability threshold in accordance with the outcome of the auction. For example, if the provider is losing a lot of auctions, it may be necessary to become more competitive by authorising the offering of less profitable bids. Similarly, if the provider is winning a lot of auctions, it may be the case that they are under negotiating and may increase their profitability threshold.

A provider who has supplied a best offer does not receive a request for a better offer until the client receives an improved offer from another provider. As such, the provider is capable of assessing the competitiveness of the offers they are supplying to the client during an auction.

For example, if a provider does not receive a request for a better offer within a given time period, they are aware that their previous offer was the best offer received and may be too competitive. Likewise, if they are continually receiving requests for better offers, they are aware that their offers are not competitive enough in light of the other offers being received from the other providers.

In the preferred embodiment, this information is utilized to adjust at least one parameter range of a bid of the strategy by means of the second feedback loop, 333b. For example, in the first example above, the range of at least one of the parameters in the next bid to be offered may be adjusted, i.e. broadened or narrowed, to produce a more profitable offer. In the second example, the range of a parameter in the next bid in the strategy may be adjusted to produce a less profitable offer, but still more profitable than the subsequent bid.

The invention is not limited to the embodiment(s) described herein but can be amended or modified without departing from the scope of the present invention.

1. An auction method operable in a first computing device arranged to communicate with a plurality of second computing devices across a network, each of said second computing devices being controlled by a respective party, the method comprising, at said first computing device:
a) generating a request comprising at least one negotiable parameter;
b) sending said request for an offer to a plurality of parties participating in the auction;
c) iteratively repeating steps d) and e) until a best offer is identified as a successful offer:
d) responsive to receiving a respective offer from a plurality of said parties, each offer comprising a value for each of one or more parameters including said at least one negotiable parameter, identifying a current best offer by combining said parameter values to provide a ranking value for each offer and comparing said ranking values for each offer; and
e) responsive to failing to identify said current best offer as a successful offer, sending a request for a better offer to at least some of said parties; and
f) accepting said successful offer;
wherein a successful offer is identified as the current best offer at a time when a same offer has been twice received from each respective provider.

2. The method according to claim 1 wherein said request further comprises at least one non-negotiable parameter.

3. The method according to claim 2 wherein said negotiable and non-negotiable parameters are any combination of continuous, categorical and discrete ordinal parameters.

4. The method according to claim 1 wherein said parameters are weighted in accordance with a user's preference.

5. The method according to claim 1 wherein step e) comprises sending said request for a better offer to those parties not having sent the offer identified as the current best offer.

6. The method according to claim 1 wherein step e) comprises sending said request for a better offer to those parties from whom an identical offer has not been received twice.

7. The method according to claim 1 further comprising:
g) sending an indication of success to the party from whom the successful offer was received.

8. The method according to claim 1 further comprising:
g) sending an indication of failure to those parties from whom the successful offer was not received.

9. The method according to claim 1 wherein said generating said request comprises: utilizing information pertaining to previous auctions.

10. The method according to claim 9 wherein said information comprises previous requests, successful parties, successful offers, unsuccessful parties, unsuccessful offers, number of offers received per party, duration of auction and number of parties involved in the auctions.

11. The method according to claim 1 wherein said identifying said current best offer includes employing non-request specific information.

12. The method according to claim 11 wherein said non-request specific information comprises information derived from previous auctions.

13. The method of claim 1 wherein said identifying said current best offer includes employing a multiple criteria decision analysis method such as TOPSIS or PROMETHEE.

14. The method of claim 1 wherein said request comprises a quota selection field for pre-assigning percentages of the offer to respective ones of said parties.

15.-33. (canceled)
